(19) United States
(12) Patent Application Publication
(10) Pub. No.: US 2024/0336022 A1
(43) Pub. Date: Oct. 10, 2024

(54) Resin Reinforced ABS Molded Shell

(71) Applicant: Denis Rojas Loesch, Houston, TX (US)

(72) Inventor: Denis Rojas Loesch, Houston, TX (US)

(21) Appl. No.: 18/344,009

(22) Filed: Jun. 29, 2023

Related U.S. Application Data
(60) Provisional application No. 63/494,713, filed on Apr. 6, 2023.

(51) Int. Cl. B29C 70/68

(52) U.S. Cl. CPC B29C 70/682; B29K 2055/02

(57) ABSTRACT

A method of reinforcing thermoplastic polymer provides an Acrylonitrile Butadiene Styrene (ABS) plastic panel, a thermoforming machine, a quantity of cleaning agent, an enclosed chamber, and a quantity of resin. First, the ABS plastic panel is first shaped into a desired body through the thermoforming machine. Unwanted particulates are then removed from the desired body with the quantity of cleaning agent. The desired body is then heated to a resin-bonding temperature with the enclosed chamber that houses heaters. The quantity of resin is then layered as at least one reinforcement coating onto the desired body. Access material is then trimmed and cleaned from the desired body as the final step.

### FIELD OF THE INVENTION

The present invention generally relates to reinforcing thermoplastic polymer. More specifically, the present invention is a method of reinforcing thermoplastic polymer to manufacture reinforced shells with Acrylonitrile Butadiene Styrene (ABS) plastic panel for the hot tub, spas, and swim spas industry.

### BACKGROUND OF THE INVENTION

A hot tub refers to a large tub full of water typically used for relaxation, hydrotherapy, or pleasure. Unlike a standard bathtub, hot tubs are typically installed outside, and are much larger to accommodate multiple people. Some hot tubs may also be manufactured with powerful jets for massage purposes and platforms for sitting down. Currently, the hot tubs are manufactured with acrylic, acrylic-abs, and polyethylene-based plastics. The use of ABS directly as the shell of a hot tub is not present within the field of art or the industry. The present invention serves to be the first of its kind to utilize ABS plastic (Acrylonitrile Butadiene Styrene) to shape and reinforce into the desired product.

It is therefore an objective of the present invention to provide a method of reinforcing thermoplastic polymer (ABS) to manufacture hot tub shells. More specifically, the ABS plastic panel is first shaped through a thermoforming machine, then cleaned and covered with a quantity of resin to improve the structural integrity. As a result, the present invention is able to produce less expensive, cost-effective, and high strength shells for hot tubs or any other related products.

### BRIEF DESCRIPTION OF THE DRAWINGS

FIG. 1 is a schematic view showing the steps A-D of the overall process of the present invention.

FIG. 2 is a schematic view showing the steps E of the overall process of the present invention.

FIG. 3 is a flowchart illustrating the overall process of the present invention.

FIG. 4 is a flowchart illustrating shaping of the ABS plastic panel of the overall process of the present invention.

FIG. 5 is a flowchart illustrating removing the unwanted particulates of the overall process of the present invention.

FIG. 6 is a flowchart illustrating the layering of the single layer of resin of the overall process of the present invention.

FIG. 7 is a flowchart illustrating the layering of the multiple layers of resin of the overall process of the present invention.

FIG. 8 is a flowchart illustrating the adhering of supplemental reinforcement material after step E of the overall process of the present invention.

FIG. 9 is a flowchart illustrating the adhering of supplemental reinforcement material during step E of the overall process of the present invention.

FIG. 10 is a flowchart illustrating the adhering of supplemental reinforcement material before step E of the overall process of the present invention.

FIG. 11 is a flowchart illustrating the trimming of access material of the overall process of the present invention.

### DETAIL DESCRIPTIONS OF THE INVENTION

All illustrations of the drawings are for the purpose of describing selected versions of the present invention and are not intended to limit the scope of the present invention.

The present invention is a method of reinforcing thermoplastic polymer to be utilized with spa industry. More specifically, the present invention is able to manufacture hot tub shell from an Acrylonitrile Butadiene Styrene (ABS) plastic panel to provide a cost-effective product with reference to existing hot tub shells that are generally made with acrylic, acrylic-abs, and polyethylene-based plastics. The method of reinforcing thermoplastic polymer is explained in relation to the ABS plastic panel, a thermoforming machine, a quantity of cleaning agent, an enclosed chamber, and a quantity of resin (Step A).

The ABS plastic panel is made by polymerizing styrene and acrylonitrile in the presence of polybutadiene. The proportions can vary from 15% to 35% acrylonitrile, 5% to 30% butadiene and 40% to 60% styrene. The result is a long chain of polybutadiene crisscrossed with shorter chains of poly (styrene-co-acrylonitrile). The nitrile groups from neighboring chains, being polar, attract each other and bind the chains together, making ABS stronger than pure polystyrene. The acrylonitrile also contributes chemical resistance, fatigue resistance, hardness, and rigidity, while increasing the heat deflection temperature. The styrene gives the plastic a shiny, impervious surface, as well as hardness, rigidity, and improved processing case.

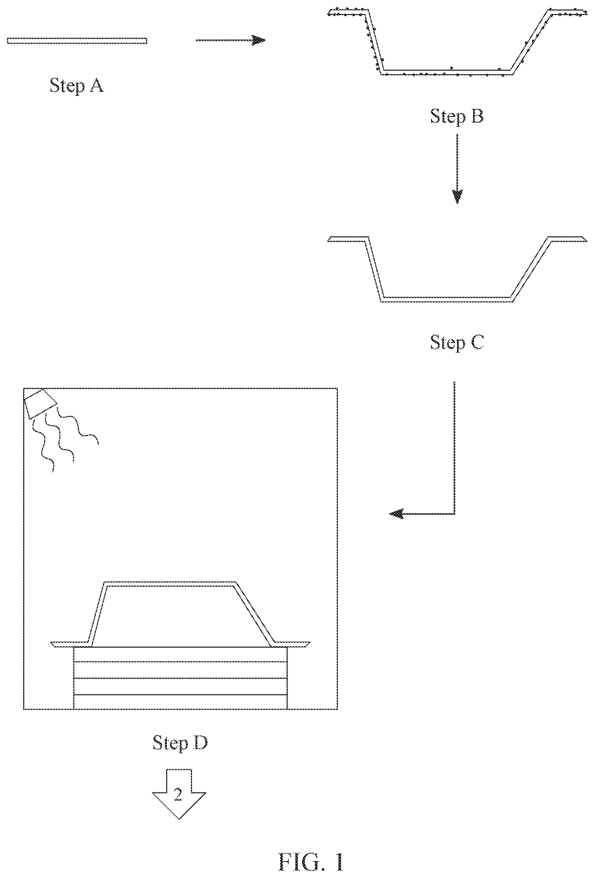

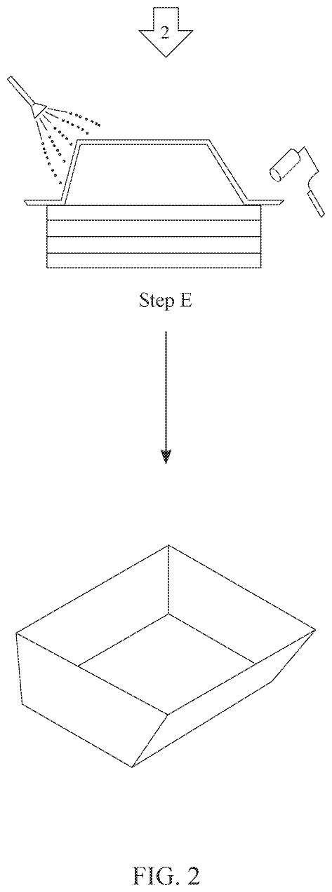

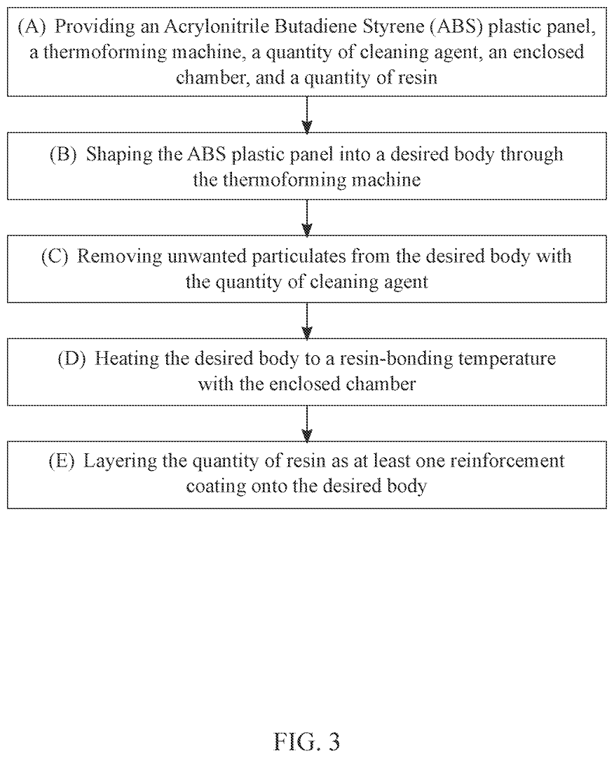

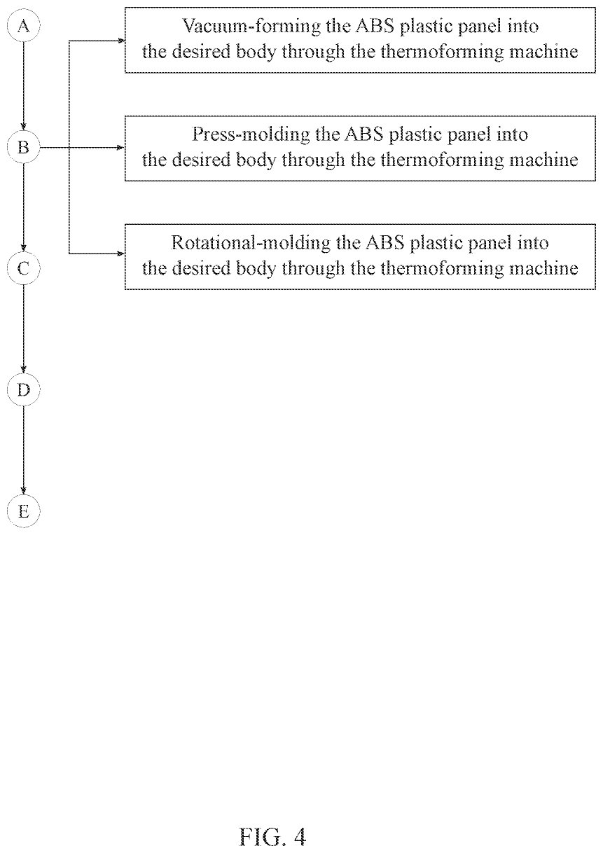

In reference to FIGS. 1-4, the ABS plastic panel is shaped into a desired body through the thermoforming machine (Step B). The desired body of the present invention is preferably a hot tub shell; however, the desired body can be any other type of object that can be shaped from the ABS plastic panel via the thermoforming machine. Shaping of the ABS plastic panel can be completed with different types of the thermoforming machines that are common to the industry. More specifically, the ABS plastic panel can be vacuum-formed into the desired body through the thermoforming machine during Step B. The ABS plastic panel can also be press-molded into the desired body through the thermoforming machine during Step B. The ABS plastic panel can also be rotational-molded into the desired body through the thermoforming machine during Step B.

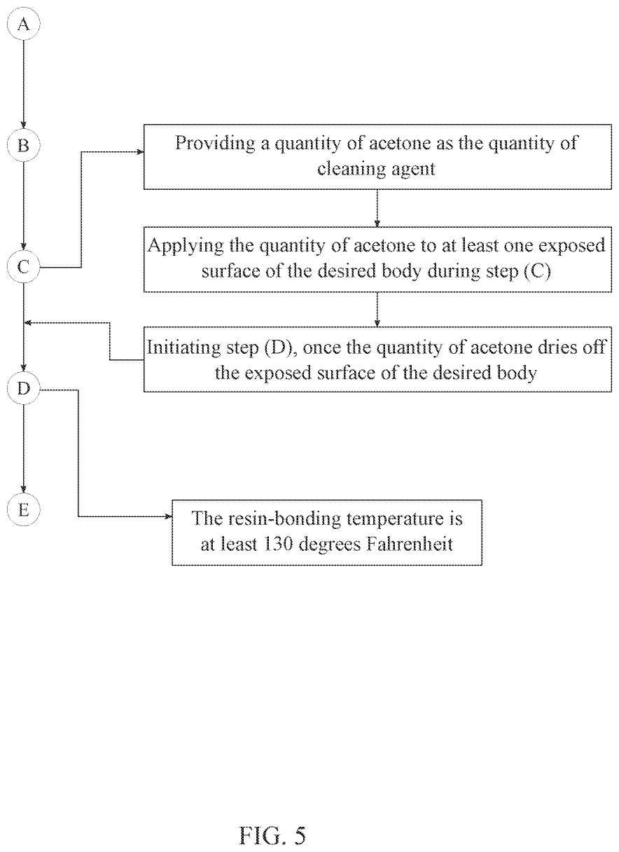

In reference to FIG. 5, once the shaping process is completed with the thermoforming machine, unwanted particulates are removed from the desired body with the quantity of cleaning agent (Step C). Preferably, a quantity of acetone is provided as the quantity of cleaning agent so that the quantity of acetone can be applied to at least one exposed surface of the desired body during Step C. However, the present invention can use any other types of solvents, alcohol isopropanol, or any other cleanings agent to remove the unwanted particulates from the at least one exposed surface. Depending upon different embodiments of the desired body, the present invention can also utilize a compressed air flow to remove the unwanted particulates in addition to the quantity of cleaning agent. Then, the exposed surface of the desired body is completely dried until the quantity of acetone is evaporated. More specifically, the desired body can be air-dried or placed with a drying-chamber to accelerate the drying process.

In reference to FIG. 5, the desired body is then heated to a resin-bonding temperate with the enclosed chamber (Step D) after Step C. More specifically, the desired body is placed with the enclosed chamber so that integrated heating units of the enclosed chamber can uniformly heat the desired body. Preferably, the resin-bonding temperature is set about 130 degrees Fahrenheit as the resin-bonding temperature can vary around 130 degrees Fahrenheit depending upon the resin type, color, and thickness. Furthermore, the resin-bonding temperature also opens up pours of the desired body to maximize the bonding strength of the quantity of resin.

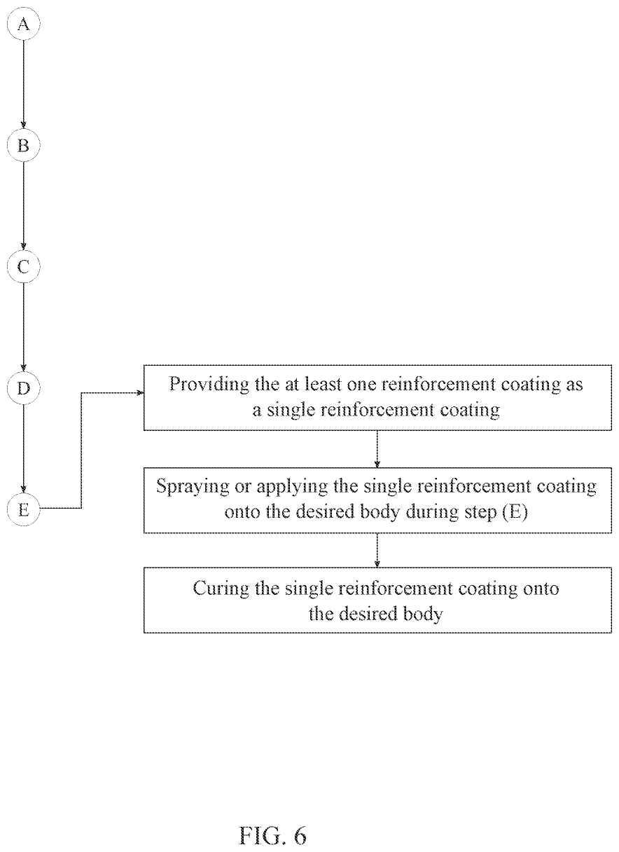

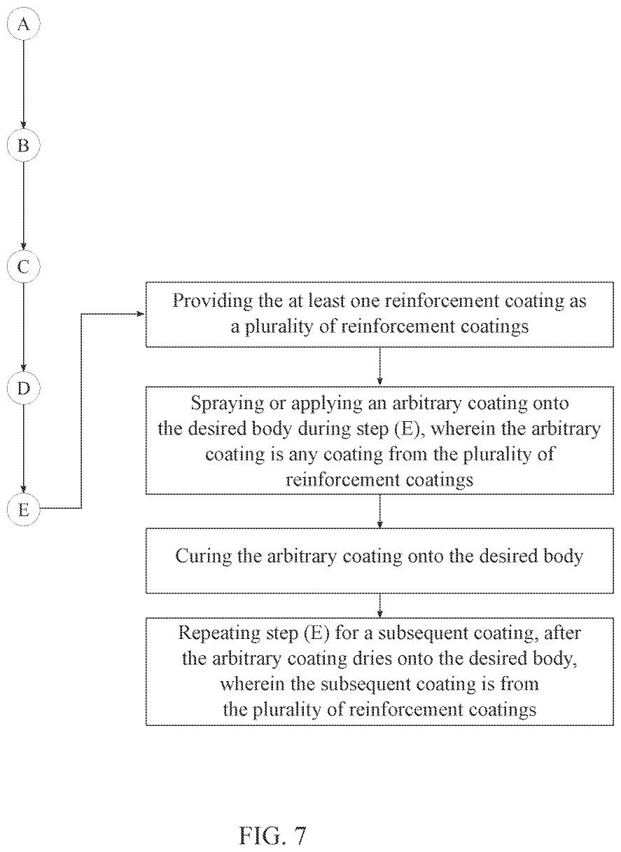

In reference to FIG. 6 and FIG. 7, the desired body is layered with the quantity of resin as at least one reinforcement coating (Step E). The quantity of resin within the present invention can include, but is not limited to, polyester (PES)-fiber based, PES-non fiber based, Polyurethane (PU)-fiber Based, PU-Composite and/or pure Polyurethane or Polyuria. Depending upon different embodiments of the desired body, the present invention may require single reinforcement coating or multiple reinforcement coatings. When the at least one reinforcement coating is a single reinforcement coating, the single reinforcement coating is sprayed or applied onto the desired body during Step E and allows the single reinforcement coating to be cured onto the desired body. When the at least one reinforcement coating is a plurality of reinforcement coatings, an arbitrary coating is sprayed or applied onto the desired body during Step E, wherein the arbitrary coating is any coating from the plurality of reinforcement coatings. Once the arbitrary coating is cured onto the desired body, Step E is repeated for a subsequent coating, after the arbitrary coating dries onto the desired body, wherein the subsequent coating is from the plurality of reinforcement coatings.

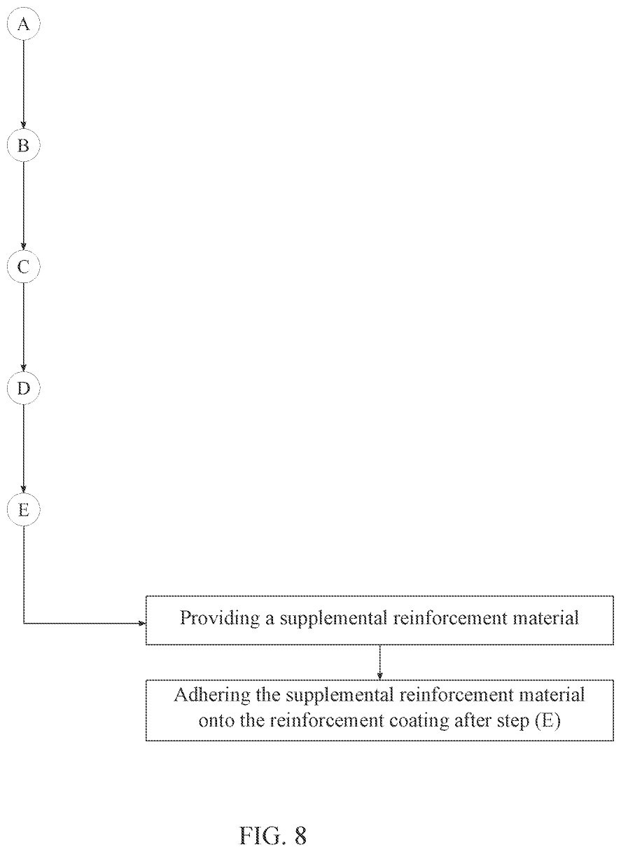

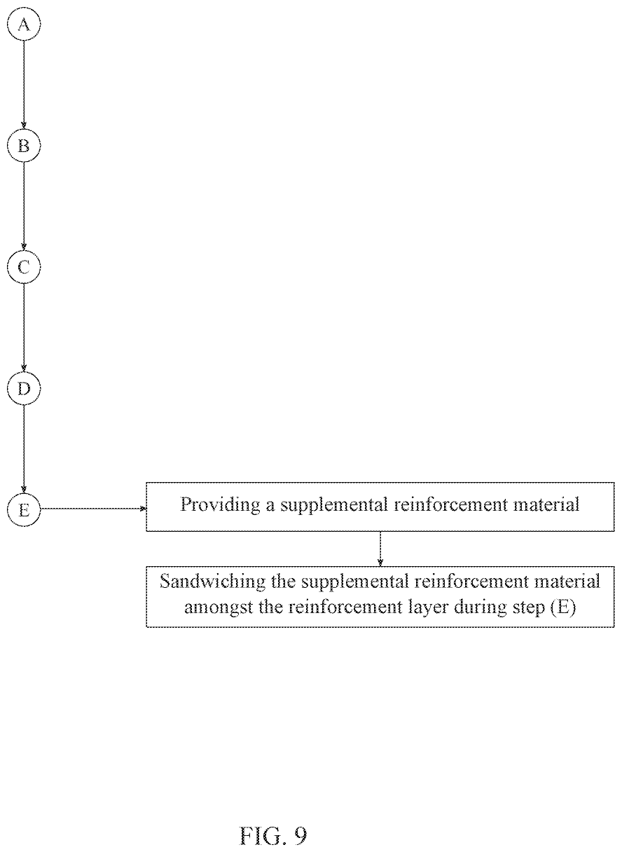

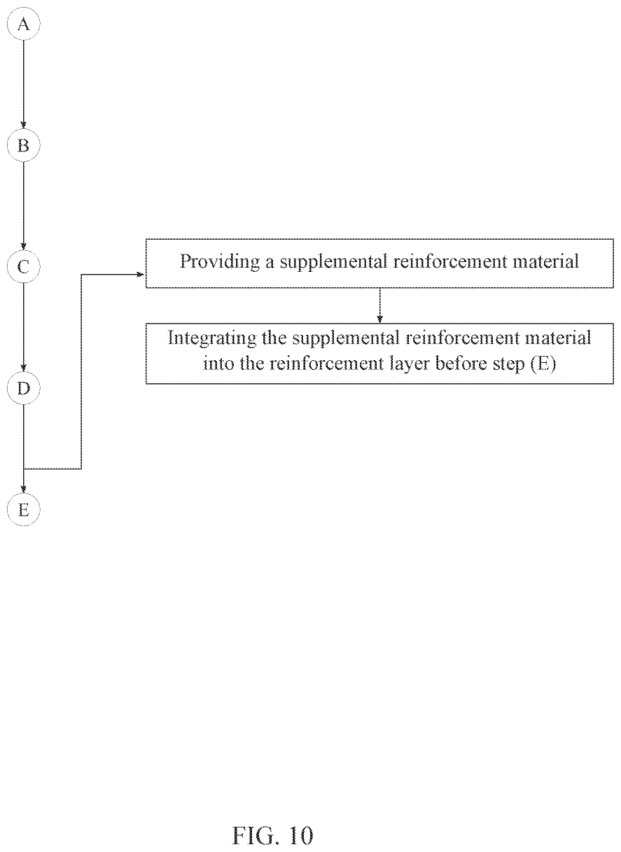

In reference to FIGS. 8-10, the present invention can be provided with a supplemental reinforcement material to enhance the structural integrity and mechanical properties of the desired body. The supplemental reinforcement material can include, but is not limited to, cardboard, plywood, metal, fiber glass, or any other types of reinforcing composites. In reference to some embodiments of the desired body, the supplemental reinforcement material is adhered onto the reinforcement coating after Step E. In reference to some embodiments of the desired body, the supplemental reinforcement material is sandwiched amongst the reinforcement coating during Step E. In reference to some embodiments of the desired body, the supplemental reinforcement material is integrated into the reinforcement coating before Step E.

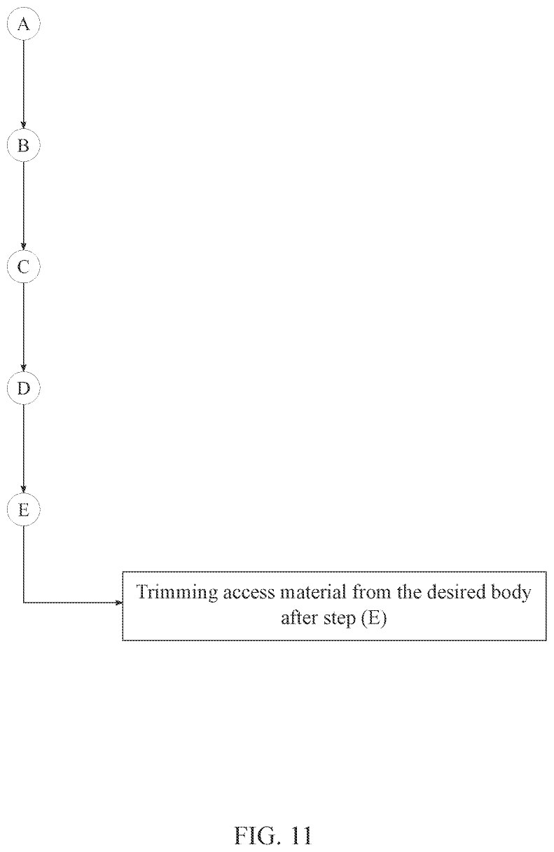

Once Step E is completed, the present invention is able to produce a rigid desired body that is resistant to chemical and mechanical reactions. In reference to FIG. 11, access material is trimmed from the desired body after Step E to remove sharp edges and material buildup thus finalized the reinforcement of thermoplastic polymer. Furthermore, it is important to note that the Steps B-F are executed in sequence to complete the reinforcement of thermoplastic polymer.

Although the invention has been explained in relation to its preferred embodiment, it is to be understood that many other possible modifications and variations can be made without departing from the spirit and scope of the invention as hereinafter claimed.

What is claimed is:

1. A method of reinforcing thermoplastic polymer, the method comprising the steps of:
(A) providing an Acrylonitrile Butadiene Styrene (ABS) plastic panel, a thermoforming machine, a quantity of cleaning agent, an enclosed chamber, and a quantity of resin;
(B) shaping the ABS plastic panel into a desired body through the thermoforming machine;
(C) removing unwanted particulates from the desired body with the quantity of cleaning agent;
(D) heating the desired body to a resin-bonding temperature with the enclosed chamber; and
(E) layering the quantity of resin as at least one reinforcement coating onto the desired body.

2. The method as claimed in claim 1, wherein steps (B) through (F) are executed in sequence.

3. The method as claimed in claim 1 comprising the step of:
vacuum-forming the ABS plastic panel into the desired body through the thermoforming machine during step (B).

4. The method as claimed in claim 1 comprising the step of:
press-molding the ABS plastic panel into the desired body through the thermoforming machine during step (B).

5. The method as claimed in claim 1 comprising the step of:
rotational-molding the ABS plastic panel into the desired body through the thermoforming machine during step (B).

6. The method as claimed in claim 1 comprising the steps of:
providing a quantity of acetone as the quantity of cleaning agent;
applying the quantity of acetone to at least one exposed surface of the desired body during step (C); and
initiating step (D), once the quantity of acetone dries off the exposed surface of the desired body.

7. The method as claimed in claim 1, wherein the resin-bonding temperature is about 130 degrees Fahrenheit.

8. The method as claimed in claim 1 comprising the steps of:
providing the at least one reinforcement coating as a single reinforcement coating;
spraying or applying the single reinforcement coating onto the desired body during step (E); and
curing the single reinforcement coating onto the desired body.

9. The method as claimed in claim 1 comprising the steps of:
providing the at least one reinforcement coating as a plurality of reinforcement coatings;
spraying or applying an arbitrary coating onto the desired body during step (E), wherein the arbitrary coating is any coating from the plurality of reinforcement coatings;
curing the arbitrary coating onto the desired body; and
repeating step (E) for a subsequent coating, after the arbitrary coating dries onto the desired body, wherein the subsequent coating is from the plurality of reinforcement coatings.

10. The method as claimed in claim 1 comprising the steps of:
providing a supplemental reinforcement material; and
adhering the supplemental reinforcement material onto the reinforcement coating after step (E).

11. The method as claimed in claim 1 comprising the steps of:
providing a supplemental reinforcement material; and
sandwiching the supplemental reinforcement material amongst the reinforcement layer during step (E).

12. The method as claimed in claim 1 comprising the steps of:
providing a supplemental reinforcement material; and
integrating the supplemental reinforcement material into the reinforcement layer before step (E).

13. The method as claimed in claim 1 comprising the step of:
trimming access material from the desired body after step (E).
